(19) United States
(12) Patent Application Publication
(10) Pub. No.: US 2025/0115065 A1
(43) Pub. Date: Apr. 10, 2025

(54) SHEET CONVEYANCE APPARATUS, AND IMAGE FORMING APPARATUS EQUIPPED WITH THE SAME

(71) Applicant: CANON KABUSHIKI KAISHA, Tokyo (JP)

(72) Inventors: MAKOTO MATSUO, Ibaraki (JP); NOBUYUKI YOMODA, Chiba (JP); AKIHIRO FUJIWARA, Chiba (JP); YURI SHIMAMOTO, Chiba (JP); YUSHI SADAMITSU, Tokyo (JP)

(21) Appl. No.: 18/894,188

(22) Filed: Sep. 24, 2024

(30) Foreign Application Priority Data
Oct. 4, 2023 (JP) 2023-172852

(51) Int. Cl. B41J 13/08; B41J 11/00; B41J 13/02

(52) U.S. Cl. CPC B41J 13/08; B41J 11/0024; B41J 13/025

(57) ABSTRACT

A sheet conveyance apparatus includes a belt, a first roller configured to stretch the belt on a downstream side of a sheet conveyance surface of the belt in a direction of rotation of the belt, a second roller configured to stretch the belt on an upstream side of the sheet conveyance surface, a third roller configured to stretch the belt at a position upstream of the second roller in the direction of rotation, a steering roller disposed between the first roller and the third roller in the direction of rotation, and a tension roller. At least one of the second roller and the third roller is a heating roller. The tension roller is configured to press a stretched portion of the belt that is stretched by the second roller and the third roller from an outer side toward an inner side to apply the tension to the belt.

### BACKGROUND OF THE INVENTION

### Field of the Invention

The present invention relates to a sheet conveyance apparatus for conveying sheets on a belt that is stretched across a plurality of rollers in a rotatable manner, and an image forming apparatus equipped with the sheet conveyance apparatus.

### Description of the Related Art

Hitherto, in image forming apparatus adopting an ink-jet system, sheets are heated through a belt on which the sheets are conveyed, by which the ink applied to the sheets is dried. The belt is stretched across a plurality of rollers, such as a driving roller that drives the belt to rotate, a heating roller that heats the belt, a steering roller that suppresses meandering of the belt, and a tension roller that applies a constant tension to the belt. Hitherto, as according to an apparatus disclosed in Japanese Patent Application Laid-Open Publication No. 2020-90344, a function to apply tension to the belt by the tension roller and a function to control meandering of the belt by a steering roller are provided separately.

### SUMMARY OF THE INVENTION

According to one aspect of the present invention, a sheet conveyance apparatus configured to convey a sheet, includes a belt having an endless shape configured to rotate and convey a sheet, a first roller configured to stretch the belt on a downstream side of a sheet conveyance surface of the belt conveying the sheet in a direction of rotation of the belt, a second roller configured to stretch the belt on an upstream side of the sheet conveyance surface in the direction of rotation, a third roller configured to stretch the belt at a position upstream of the second roller in the direction of rotation, a steering roller disposed between the first roller and the third roller in the direction of rotation and configured to tilt and move the belt in a width direction intersecting the direction of rotation, and a tension roller configured to apply a tension to the belt. At least one of the second roller and the third roller is a heating roller configured to heat the belt. The tension roller is configured to press a stretched portion of the belt that is stretched by the second roller and the third roller from an outer side toward an inner side to apply the tension to the belt.

Further features of the present invention will become apparent from the following description of exemplary embodiments with reference to the attached drawings.

### BRIEF DESCRIPTION OF THE DRAWINGS

FIG. 1 is a schematic drawing illustrating an inkjet recording apparatus.

FIG. 2 is a schematic cross-sectional view illustrating a drying module.

FIG. 3 is a perspective view illustrating a steering unit viewed from a front side.

FIG. 4 is a perspective view illustrating the steering unit viewed from a rear side.

FIG. 5 is a perspective view illustrating a tension unit.

FIG. 6 is a perspective view illustrating the tension unit in a state where tension is released by one level.

FIG. 7 is a perspective view illustrating the tension unit in a state where tension is released by two levels.

FIG. 8 is a view illustrating an attachment of the tension unit.

FIG. 9 is a perspective view illustrating a supporting configuration of a right door portion and a wiring configuration of a bundle wire.

FIG. 10 is a schematic cross-sectional view illustrating a belt stretched state when the belt is stretched.

### DESCRIPTION OF THE EMBODIMENTS

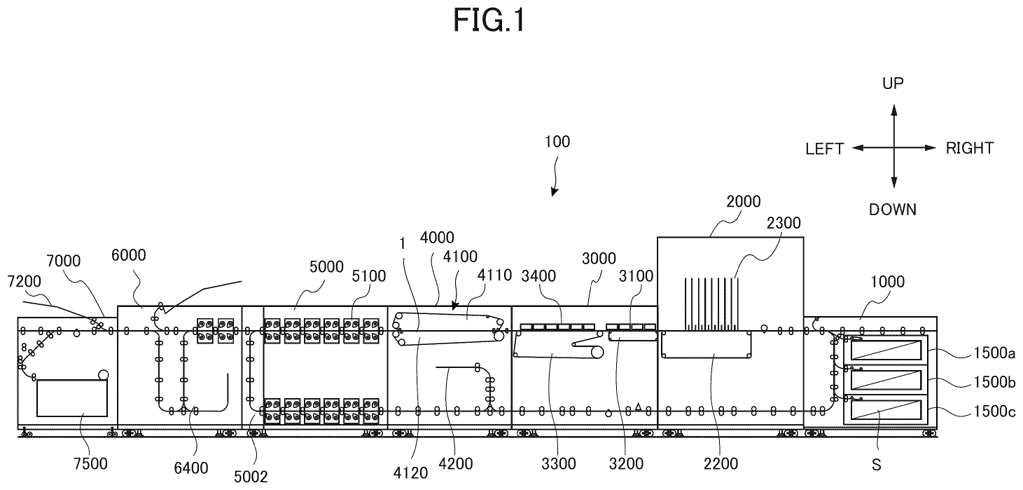

Embodiments of the present invention will be described below with reference to the drawings. At first, an image forming apparatus according to the present embodiment will be described with reference to FIG. 1. In the description, an inkjet recording apparatus 100 of a so-called sheet-by-sheet type for forming images on sheets using ink and reaction liquid will be described as an example of the image forming apparatus. The sheet may be any recording material capable of receiving application of ink, including paper such as normal paper and thick paper, a plastic film such as an overhead projector sheet, a special-shaped sheet such as an envelope or an index paper, and cloth.

Further, in the present specification, a side on which an operator stands when operating the inkjet recording apparatus 100 is called a “front side, or front”, and the side opposite thereto is called a “rear side, or back”. Further, a left seen from the front side is called “left”, and a right seen from the front side is called “right”.

### Inkjet Recording Apparatus

As illustrated in FIG. 1, the inkjet recording apparatus 100 is equipped with a sheet feeding module 1000, a printing module 2000, a drying module 3000, a fixing module 4000, a cooling module 5000, a reversing module 6000, and a supporting module 7000. A sheet S supplied from the sheet feeding module 1000 is subjected to various processes while being conveyed in the respective modules along a conveyance path and finally discharged to the supporting module 7000.

Each of the sheet feeding module 1000, the printing module 2000, the drying module 3000, the fixing module 4000, the cooling module 5000, the reversing module 6000, and the supporting module 7000 may have different casings, and the casings may be connected together to form the inkjet recording apparatus 100. Alternatively, the sheet feeding module 1000, the printing module 2000, the drying module 3000, the fixing module 4000, the cooling module 5000, the reversing module 6000, and the supporting module 7000 may be arranged in one casing.

The sheet feeding module 1000 has storage cassettes 1500a, 1500b, and 1500c for storing the sheets S, and the storage cassettes 1500a to 1500c may be drawn out to the front side to store the sheets S. The sheets S are fed one sheet at a time from the respective storage cassettes 1500a to 1500c via a separation belt and a conveyance roller, and conveyed to the printing module 2000. The number of storage cassettes 1500a to 1500c is not limited to three, and it may be one, two, or even more than four.

The printing module 2000 includes a pre-image-forming conveyance unit (not shown), a printing belt unit 2200, and a storage unit 2300. The sheet S conveyed from the sheet feeding module 1000 is sent to the pre-image-forming conveyance unit, where the sheet S is subjected to skew correction and position correction, and conveyed to the printing belt unit 2200.

The storage unit 2300 is arranged at a position facing the printing belt unit 2200 with respect to the conveyance path of the sheet S. The storage unit 2300 serving as an image forming unit ejects ink onto the sheet S via a plurality of recording heads from above to the sheet S being conveyed on the printing belt, and forms an image. A clearance between the sheet S and the recording heads is ensured by having the sheet S sucked while being conveyed on the printing belt unit 2200. According to the present embodiment, a total of five line-type recording heads, which correspond to four colors of yellow (Y), magenta (M), cyan (C), and black (Bk), and reaction liquid, are arranged along a conveyance direction of the sheet S.

The number of colors of the ink and the number of recording heads are not limited to five. An inkjet system used to eject ink may adopt a system using heating elements, a system using piezoelectric elements, a system using electrostatic elements, or a system using Micro Electro Mechanical Systems (MEMS) elements. The inks of respective colors are supplied from ink tanks not shown through respective ink tubes to the recording heads. The ink contains, with the total mass of ink set as reference, “0.1 mass % to 20.0 mass %” of resin component, and water, water-soluble organic solvent, coloring material, wax, and additives.

An inline scanner not shown is arranged downstream in a conveyance direction of the storage unit 2300. The sheet S on which image is formed in the storage unit 2300 is conveyed by the printing belt unit 2200 to an inline scanner (not shown), and image formed on the sheet S is read by the inline scanner (not shown). During this process, deviation and color density of the image formed on the sheet S is detected, and based on the deviation and color density of the image, correction of image and density formed on the sheet S is performed.

The drying module 3000 includes a cool air blowing unit 3100, a decoupling belt unit 3200, a drying belt unit 3300, and a warm air blowing unit 3400. The drying module 3000 reduces a liquid portion of the ink applied to the sheet S to enhance a fixing property of the ink to the sheet S by the subsequent fixing module 4000.

The sheet S on which the image has been formed is conveyed to the decoupling belt unit 3200 arranged within the casing of the drying module 3000. In the decoupling belt unit 3200, frictional force is generated between the sheet S and the belt by wind pressure of wind blown from above, and the sheet S is conveyed on the belt. By having the sheet S placed on the belt conveyed by friction force in this manner, it may be possible to prevent deviation of the sheet S when the sheet S is conveyed from a printing belt unit 2010 to the decoupling belt unit 3200.

The sheet S conveyed from the decoupling belt unit 3200 is conveyed from the drying belt unit 3300 serving as a sheet conveyance apparatus, and the ink applied to the sheet S is dried by having warm air blown from the warm air blowing unit 3400 arranged above the belt. By having the ink applied on the sheet S heated by the drying module 3000 and evaporation of moisture promoted, it may be possible to suppress the occurrence of a so-called cockling in which ink is scattered on the sheet S and a line that forms a frame-like mark around the ink is formed. Any device capable of heating and drying may be used as the drying module 3000, but it is preferable to use a warm air drier or a heater, for example. The heater preferably realizes heating, for example, by a heating wire or an infrared heater from the viewpoint of safety and energy efficiency.

The fixing module 4000 includes a fixing belt unit 4100. The fixing belt unit 4100 fixes the ink on the sheet S by having the sheet S conveyed from the drying module 3000 pass through between an upper belt unit 4110 and a lower belt unit 4120 being heated.

The cooling module 5000 includes a cooling portion 5100, and cools the sheet S heated to high temperature conveyed from the fixing module 4000. The cooling portion 5100 cools the sheet S by increasing the pressure inside a cooling box by taking in outer air to the cooling box using a fan and blowing air through the nozzle formed on the conveyance guide to the sheet S. The cooling portion 5100 is arranged on both sides of the conveyance path of the sheet S so as to cool the sheet S from both sides.

Further, the cooling module 5000 has a conveyance path switching portion 5002 disposed therein. The conveyance path switching portion 5002 switches the conveyance path of the sheet S in response to a case where the sheet S is conveyed in the reversing module 6000 and to a case where the sheet S is conveyed to a duplex conveyance path for performing duplex printing in which images are formed on both sides of the sheet S.

The reversing module 6000 includes a reverse portion 6400. The reverse portion 6400 reverses the upper and lower sides of the sheet S being conveyed, and reverses the side of the sheet S facing upward when the sheet is discharged to the supporting module 7000. The supporting module 7000 includes a top tray 7200 and a supporting portion 7500, and supports the sheet S conveyed from the reversing module 6000 thereon.

During duplex printing, the sheet S is conveyed by the conveyance path switching portion 5002 to a conveyance path disposed on the lower portion of the cooling module 5000. Thereafter, the sheet S is passed through the duplex conveyance path in the fixing module 4000, the drying module 3000, the printing module 2000, and the sheet feeding module 1000 to be returned to the printing module 2000. A reverse portion 4200 for reversing the sides of the sheet S is disposed on a duplex conveyance portion of the fixing module 4000. The sheet S returned to the printing module 2000 has an image formed by ink on the other side surface where image has not yet been formed, and the sheet S is conveyed through the drying module 3000, the fixing module 4000, the cooling module 5000, and the reversing module 6000 to be discharged to the supporting module 7000.

### Drying Module

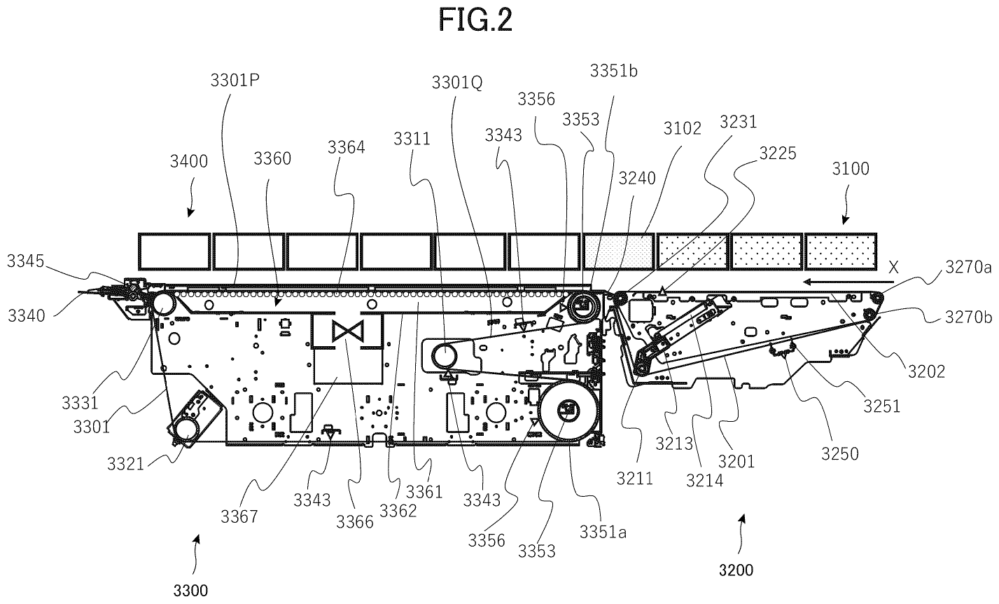

Next, a configuration of the drying module 3000 will be described with reference to FIG. 2. As illustrated in FIG. 2, in the decoupling belt unit 3200, a decoupling belt 3201 is stretched across a driving roller 3231, a tension roller 3211, and stretch rollers 3270a and 3270b. The driving roller 3231, the tension roller 3211, and the stretch rollers 3270a and 3270b have their ends respectively rotatably supported on a front side panel and a rear side panel of the decoupling belt unit 3200. Among these rollers, the tension roller 3211 is rotatably supported on a slide rail 3213 in a displaceable manner in a predetermined direction, and presses the decoupling belt 3201 from an inner side toward an outer side by urging force of a tension spring 3214 to thereby apply tension to the decoupling belt 3201.

The sheet S transferred from the printing belt unit 2010 is sent to the decoupling belt unit 3200. During conveyance of the sheet S, the sheet S is pressed against the decoupling belt 3201 by blowing of air from the cool air blowing unit 3100 arranged above the decoupling belt unit 3200, and conveyed thereon. The decoupling belt 3201 has a number of holes formed thereon, and the belt is supported by a punching metal 3202 arranged on an inner side of the decoupling belt 3201. Holes smaller than the holes on the decoupling belt 3201 are formed on the punching metal 3202, such that air from the cool air blowing unit 3100 blown to areas other than the sheet S may escape therethrough. Further, the decoupling belt 3201 is destaticized by a destaticizing portion 3250 so as to prevent the decoupling belt 3201 from being charged by the friction between the sheet S and the decoupling belt 3201 and causing excessive restraining force from being generated to the sheet S.

The sheet S conveyed to the decoupling belt 3201 is passed through an inner sheet discharge guide 3240 and sent to the drying belt unit 3300. An endless drying belt 3301 of the drying belt unit 3300 is stretched across a driving roller 3331, a heating roller 3351a, a heating roller 3351b, a tension roller 3311, and a steering roller 3321 that are fixed in a rotatable manner. The drying belt 3301 is driven by the rotation of the driving roller 3331.

In the present embodiment, the driving roller 3331 serving as a first roller stretches and drives the drying belt 3301 at a position downstream of a sheet conveyance surface 3301P of the drying belt 3301 for conveying the sheet S with respect to a direction of rotation of the drying belt 3301, i.e., arrow X direction. The heating roller 3351b serving as a second roller stretches and heats the drying belt 3301 upstream, i.e., upstream in the direction of rotation, of the sheet conveyance surface 3301P. The heating roller 3351a serving as a third roller stretches and heats the drying belt 3301 upstream of the heating roller 3351b. A conveyance surface 3301P of the sheet does not necessarily have to be of a same height as the driving roller 3331 and the heating roller 3351b, and the conveyance surface 3301P of the sheet may be arranged higher in a vertical direction than the driving roller 3331 and the heating roller 3351b. Further, according to the present embodiment, five rollers are illustrated as being in contact with the drying belt 3301, but the number of rollers being in contact with the drying belt 3301 maybe more than five.

The warm air blowing unit 3400 arranged on an upper portion of the drying belt unit 3300 blows warm air heated by a heater to the drying belt unit 3300. A suction unit 3360 is disposed on an inner side of the sheet conveyance surface 3301P of the drying belt 3301. In the suction unit 3360, the suction chamber 3361 is formed by a suction duct 3362 and the drying belt 3301, wherein by having a fan 3366 discharge air to an air discharge duct 3367, negative pressure is generated in the suction chamber 3361. Since a large number of small holes of approximately “φ0.4 mm” is formed on the drying belt 3301, force for sucking the sheet S to the drying belt 3301 is generated. Due to this sucking force and a wind pressure from the warm air blowing unit 3400, the sheet S is conveyed on the sheet conveyance surface 3301P of the drying belt 3301. Further, a large number of rollers 3364 supporting the drying belt 3301 is disposed rotatably on the inner side of the drying belt 3301 at positions determined so as not to hinder the suction by the fan 3366.

In the process of conveying the sheet S by the drying belt 3301, drying of the ink applied on the sheet S is performed by having the sheet S heated by the blowing of warm air from the warm air blowing unit 3400 and also heated by the drying belt 3301. The drying belt 3301 is heated by the heating roller 3351a and the heating roller 3351b. Heaters 3353 for heating the heating rollers 3351a and 3351b respectively are disposed on the inner side of the heating rollers 3351a and 3351b. Heater temperature detection sensors 3356 are disposed on the outer side of the heating rollers 3351a and 3351b to detect surface temperatures thereof. The heaters 3353 are subjected to temperature control based on detection results by the heater temperature detection sensors 3356 such that the temperatures of the heating rollers 3351a and 3351b are set to a set temperature. Further, a noncontact-type belt temperature detection sensor 3343, such as an infrared sensor, is disposed for detecting the temperature of the drying belt 3301, and the result of detection of the belt temperature detection sensor 3343 is reflected on the temperature setting of the heaters 3353.

In order to enhance the heating efficiency of the drying belt 3301, it is effective to widen the contact area through which the heating rollers 3351a and 3351b each come into contact with the drying belt 3301. In the present embodiment, the heating roller 3351a has a diameter of “φ110 mm” and the heating roller 3351b has a diameter of “60 mm”, which are greater than the diameter of other rollers, such that the contact area is widened. Along with the conveyance of the drying belt 3301, the heat of the drying belt 3301 is released to the atmosphere or to other rollers on which the belt is stretched. Therefore, by arranging the heating roller 3351b and the heating roller 3351a upstream of the sheet conveyance surface 3301P, the sheet S may be heated efficiently.

In the present embodiment, the tension roller 3311 contributes to enhancing the heating efficiency of the drying belt 3301. The tension roller 3311 presses a stretched portion 3301Q of the drying belt 3301 stretched by the heating rollers 3351a and 3351b from the outer side toward the inner side, and applies constant tension to the drying belt 3301. The tension roller 3311 moves from the outer side toward the inner side in a state where the drying belt 3301 is expanded by heat. In that state, as illustrated below, a winding angle of the drying belt 3301 on the heating rollers 3351a and 3351b is ensured so as to suppress the change of contact areas between the heating rollers 3351a and 3351b and the drying belt 3301 compared to before the belt is expanded.

The sheet S heated by the heat of the drying belt 3301 and warm air from the warm air blowing unit 3400 is conveyed to an inner sheet discharge unit 3340, and thereafter discharged by an inner sheet discharge roller 3345 to the fixing module 4000. In the drying module 3000, the drying belt unit 3300 is heated to approximately “80° C.” by a warm air blow unit 3401, the heating roller 3351a, and the heating roller 3351b. However, in the decoupling belt unit 3200, air that is not heated is blown from the cool air blowing unit 3100 disposed on an upper portion, and an air ventilation unit 3102 disposed on an upper portion of a connecting portion with the drying belt unit 3300 discharges and sucks in the non-heated air so as to circulate air, by which warm air from the warm air blowing unit 3400 is blocked, such that temperature will not rise significantly and the effect thereof is limited.

### Steering Unit

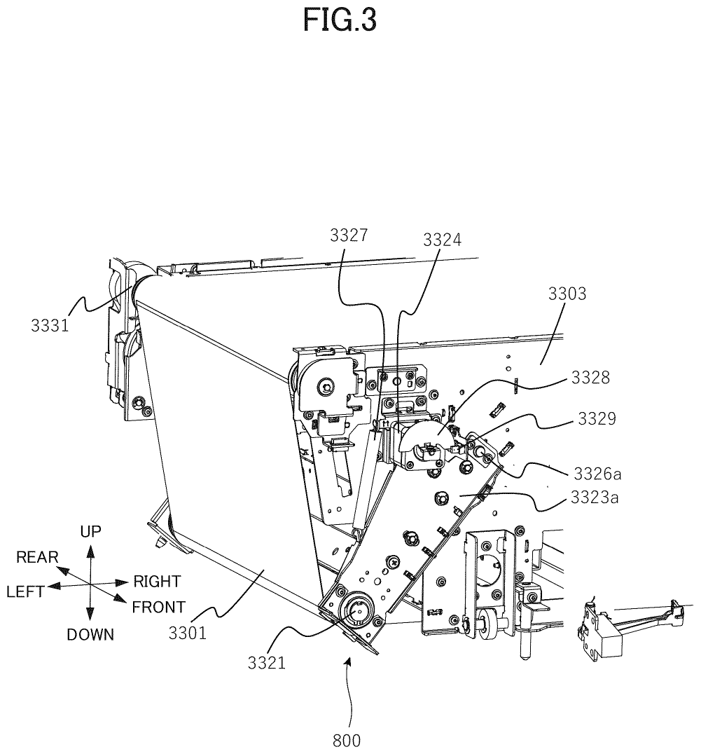

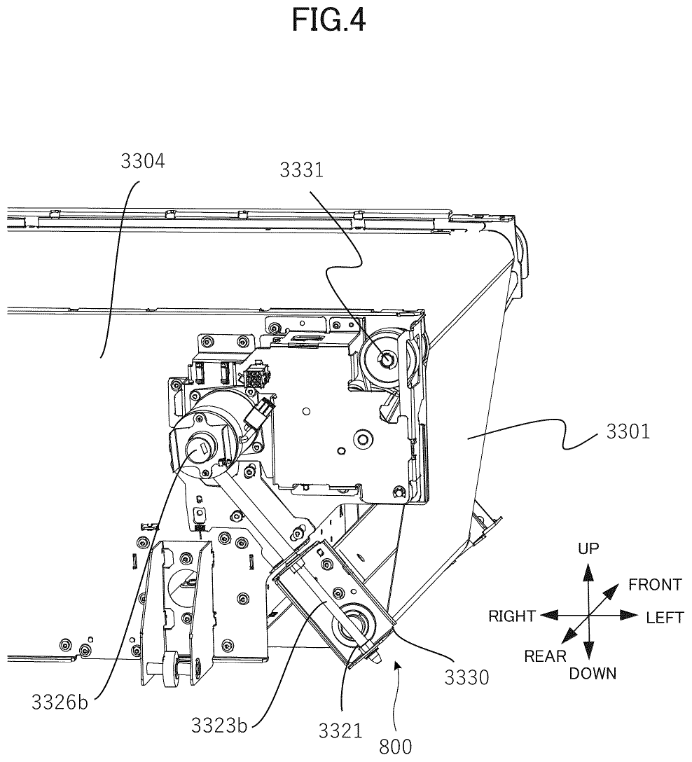

In a state where the sheet S is conveyed on the drying belt 3301, there is a need to perform position control of the drying belt 3301 so as not to cause a great deviation of the conveyance position of the sheet S in a width direction intersecting the direction of rotation of the drying belt 3301. In the present embodiment, the steering roller 3321 is arranged between the driving roller 3331 and the heating roller 3351a with respect to the direction of rotation of the drying belt 3301, so as to control the position of the drying belt 3301 (refer to FIG. 2). A steering unit 800 including the steering roller 3321 will be described based on FIGS. 3 and 4 with reference to FIG. 2. FIG. 3 illustrates the steering unit 800 viewed from the front side, and FIG. 4 illustrates the steering unit 800 viewed from the rear side.

As illustrated in FIG. 3, a first end of the steering roller 3321 is supported rotatably on a steering arm 3323a, and the steering arm 3323a is disposed pivotably about a pivot shaft 3326a on a front side panel 3303. Further, a steering motor 3324 supports an eccentric steering cam (not shown). A portion of the steering arm 3323a is urged toward a direction to be abutted against the steering cam by a steering arm spring 3327. In response to the steering cam being rotated by the steering motor 3324, the steering arm 3323a is pivoted corresponding to the amount of eccentricity of a steering cam 3322. A flag 3328 is disposed rotatably on an opposite side from the steering cam of the steering motor 3324, and a flag sensor 3329 detects the flag 3328. By having an amount of rotation of the steering motor 3324 controlled according to a detection result of the flag sensor 3329, a pivoting amount of the steering roller 3321 is determined.

Meanwhile, as illustrated in FIG. 4, a second end of the steering roller 3321 is rotatably supported on a steering arm 3323b, and the steering arm 3323b is disposed pivotably about a pivot shaft 3326b on a rear side panel 3304. The steering arm 3323b pivots so as to absorb the torsion that occurs when the steering arm 3323a mentioned above pivots, but it does not change the position of the steering roller 3321 greatly.

The steering arm 3323a pivots according to this configuration and tilts the steering roller 3321, by which a thrust force in a width direction, i.e., pivot axis direction, occurs to the drying belt 3301, and the position of the drying belt 3301 may be controlled. It may be possible to adopt a configuration that does not include the pivot shaft 3326b, wherein the steering arm 3323b is fixed to the rear side panel 3304, and the torsion that occurs to the steering roller 3321 when the steering arm 3323a pivots may be absorbed by the backlash of a supporting portion 3330 that supports the steering roller 3321.

### Tension Unit

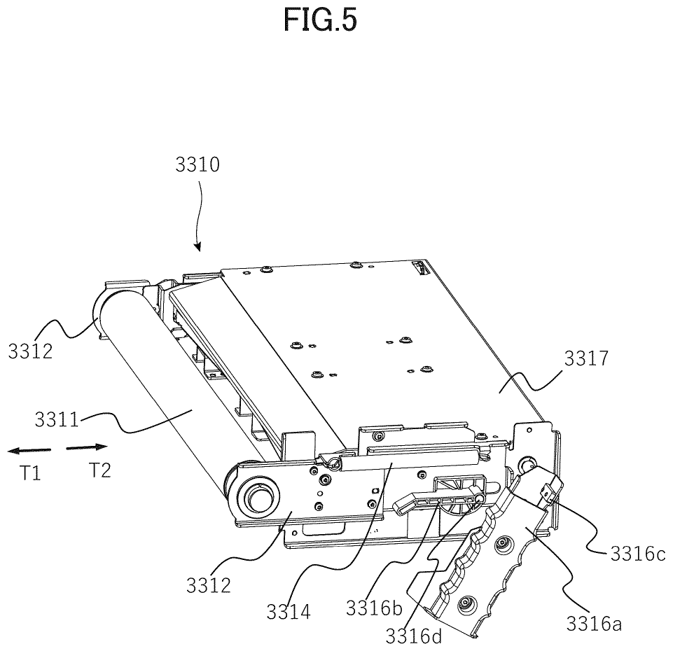

As described above, the tension roller 3311 presses the drying belt 3301 from the outer side toward the inner side, and applies constant tension to the drying belt 3301. A tension unit 3310 that includes the tension roller 3311 will be described based on FIGS. 5 to 9 with reference to FIG. 2.

FIG. 5 illustrates the tension unit 3310. The tension unit 3310 is a unit that is detachably attached to the drying belt unit 3300. The tension roller 3311 is pivotably supported on a tension arm 3312, and the tension arm 3312 is supported movably in a predetermined direction along a slide rail (not shown) with respect to a tension frame 3317. By having the tension arm 3312 urged by a plurality of tension springs 3314, the tension roller 3311 is urged toward an urging direction T1 from the outer side toward the inner side via the tension arm 3312. According to the present embodiment, in a state where the tension unit 3310 is assembled to the drying belt unit 3300 and urges the drying belt 3301, a tension of “40 Kgf”, for example, is applied to the drying belt 3301.

A great urging force is required to stretch the drying belt 3301 without sagging, and an operator must operate the tension unit 3310 with great force to apply or release such urging force. In order to reduce the load on the operator, the present embodiment adopts a two-level pressure release mechanism using a lever.

As illustrated in FIG. 5, a tension lever 3316a is supported on a lever shaft 3316c that extends in a rotational axis direction, i.e., width direction, of the tension roller 3311, and an eccentric cam (not shown) is disposed on the lever shaft 3316c. At the position of the tension lever 3316a illustrated in FIG. 5, an urging force of the tension spring 3314 urges the tension arm 3312 in the urging direction T1 via a link member (not shown).

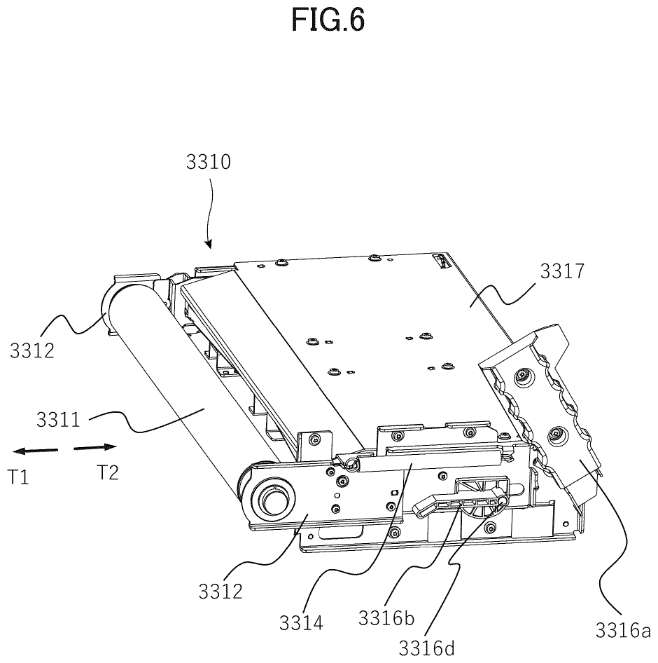

FIG. 6 illustrates a tension unit in a state where the tension is released by one level. By moving the tension lever 3316a from the position illustrated in FIG. 5 to the position illustrated in FIG. 6, the eccentric cam pushes down the link member, and causes the urging force of the tension spring 3314 not to be transmitted to the tension arm 3312. However, by moving the tension lever 3316a to the position illustrated in FIG. 6, approximately 60% of the urging force of the tension spring 3314 may be released, for example. In this state, since a tension lever 3316b is at a tension applying position, the application of tension to the drying belt 3301 is maintained. The tension lever 3316b is supported on a lever shaft 3316d that extends in the rotational axis direction, i.e., width direction, of the tension roller 3311, and the lever shaft 3316d is equipped with an eccentric cam (not shown).

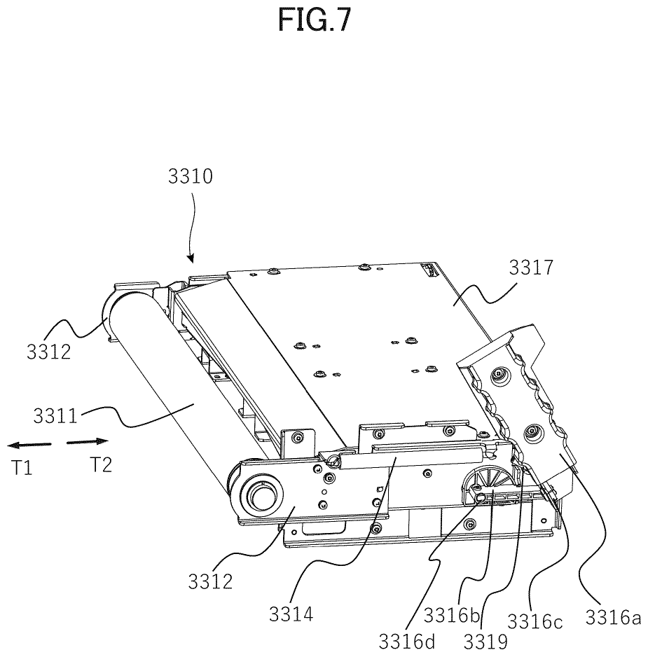

FIG. 7 illustrates a tension unit in a state where tension is released by two levels. At the position of the tension lever 3316b illustrated in FIG. 6, the force of the tension spring 3314 urges the tension arm 3312 in the urging direction T1. By moving the tension lever 3316b from the position illustrated in FIG. 6 to the position illustrated in FIG. 7, the eccentric cam pushes down the tension arm 3312, such that urging force from the tension spring 3314 will not be transmitted to the tension arm 3312. That is, the remaining approximately 40% of the urging force of the tension spring 3314 will be released. Thereby, the tension applied to the drying belt 3301 will be completely released, such that the tension roller 3311 may be moved to a retreating direction T2. In this state, by having the tension arm 3312 that has been retreated enter a pivot locus of an abutment member 3319 that moves in linkage with the movement of the lever shaft 3316c, a configuration is realized to prevent the operator from performing erroneous operation procedures of the tension lever 3316a and the tension lever 3316b. The configuration used for the application and release of tension is not limited to a lever, and a configuration may be adopted to apply tension by stretching the wire.

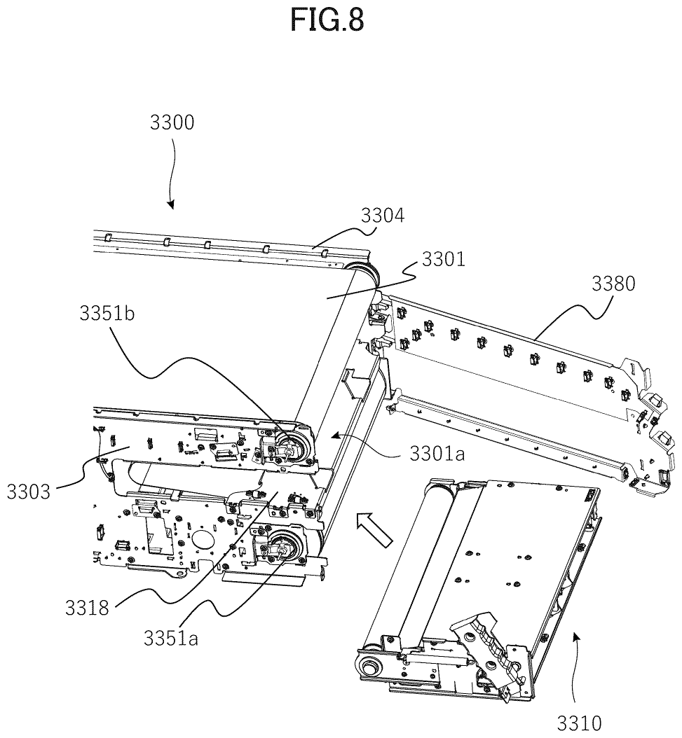

Next, attachment of the tension unit 3310 will be described with reference to FIG. 8. As illustrated in FIG. 8, by operating the tension lever 3316a and the tension lever 3316b, the tension unit 3310 having the tension roller 3311 retreated is attached from the right side of the drying belt unit 3300. In order to facilitate attachment of the tension unit 3310, a right door portion 3380 is disposed on the rear side panel 3304 pivotably about a pivot shat extending along an up-down direction. By opening the right door portion 3380, an opening portion 3301a of the tension unit 3310 is released, and the tension unit 3310 may be inserted into the drying belt unit 3300 through the released opening portion 3301a. In order to prevent the tension unit 3310 from colliding against the drying belt 3301 or the heating roller 3351a and the heating roller 3351b when inserting the tension unit 3310, a guide plate 3318 that is extended across the front side panel 3303 and the rear side panel 3304 is arranged on a lower side of where the tension unit 3310 is to be accommodated. By having the tension unit 3310 inserted along the guide plate 3318, the tension unit 3310 is attached to a predetermined position within the drying belt unit 3300.

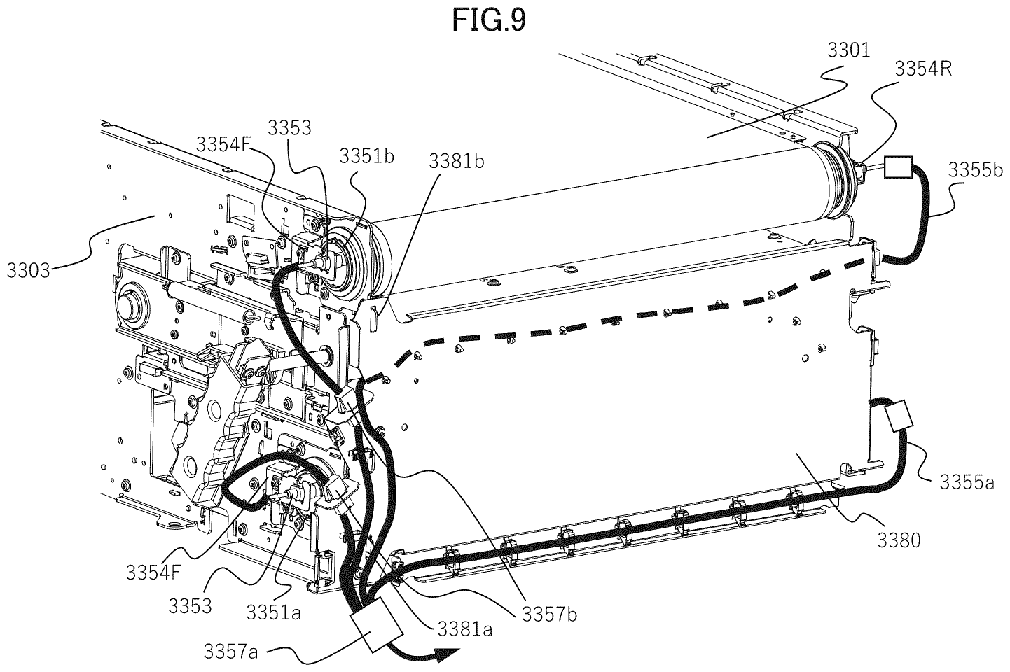

FIG. 9 illustrates a supporting configuration of the right door portion 3380 and a wiring configuration of a bundle wire. After attaching the tension unit 3310, the right door portion 3380 is closed and retained on the front side panel 3303. The right door portion 3380 is maintained in a closed state against the front side panel 3303 by being fit to a positioning portion 3381a disposed on the heating roller 3351a side of the front side panel 3303 and to a positioning portion 3381b disposed on the heating roller 3351b side of the front side panel 3303. The opening portion 3301a is formed in a U-shape between the heating roller 3351a and the heating roller 3351b on the front side panel 3303 to allow insertion of the tension unit 3310 (refer to FIG. 8). Therefore, if support is provided only by the front side panel 3303, the front side panel 3303 side will be slightly sagged by the own weight of the heating roller 3351b, causing misalignment of the heating roller 3351b on which the drying belt 3301 is stretched. In order to prevent deterioration of the belt conveyance performance caused by the disturbance of the belt stretched state, the pitch between the positioning portion 3381a and the positioning portion 3381b of the front side panel 3303 is ensured by being fitted with the right door portion 3380. Thereby, it becomes possible to prevent misalignment of the heating roller 3351b and to prevent deterioration of the belt conveyance performance.

The right door portion 3380 is used as a bundle wire path for the heater 3353. The heater 3353 is arranged within the heating roller 3351a and the heating roller 3351b, and each end in the width direction of the heater 3353 is supported by a heater supporting portion 3354F and a heater supporting portion 3354R. The present embodiment adopts a configuration to apply AC voltage to operate the heater 3353. A bundle wire 3355a and a bundle wire 3355b for applying the AC voltage are connected to an electric component portion (not shown) of the drying module 3000 and both ends of the heater 3353 via relay connectors 3357a and 3357b.

The drying belt unit 3300 may be drawn out of the drying module 3000 during maintenance operations, such that the connection thereof with the bundle wires 3355a and 3355b may be changed easily via the relay connector 3357a. Further, it is necessary to provide paths for the bundle wire 3355a and the bundle wire 3355b within the drying belt unit 3300, but since the tension unit 3310 may be inserted to and drawn out of the drying belt unit 3300, it is difficult to lay the bundle wire 3355a and the bundle wire 3355b in the vicinity of the tension unit. However, by providing a path for the bundle wire 3355a and the bundle wire 3355b on the right door portion 3380, the bundle wire may be laid through a short and simple path, and when inserting or removing the tension unit 3310, the bundle wire 3355a and the bundle wire 3355b may be retreated together with the right door portion 3380, by simply disconnecting the connection with the relay connector 3357b. Therefore, by providing the right door portion 3380, it may be possible to facilitate the insertion and removal of the tension unit 3310 and the handling of the bundle wire of the heater while maintaining the pitch between the heating roller 3351a and the heating roller 3351b at an appropriate position. The bundle wire 3355a and the bundle wire 3355b described above are not limited to the AC wire through which AC voltage is applied, but may be a DC wire through which DC voltage is applied.

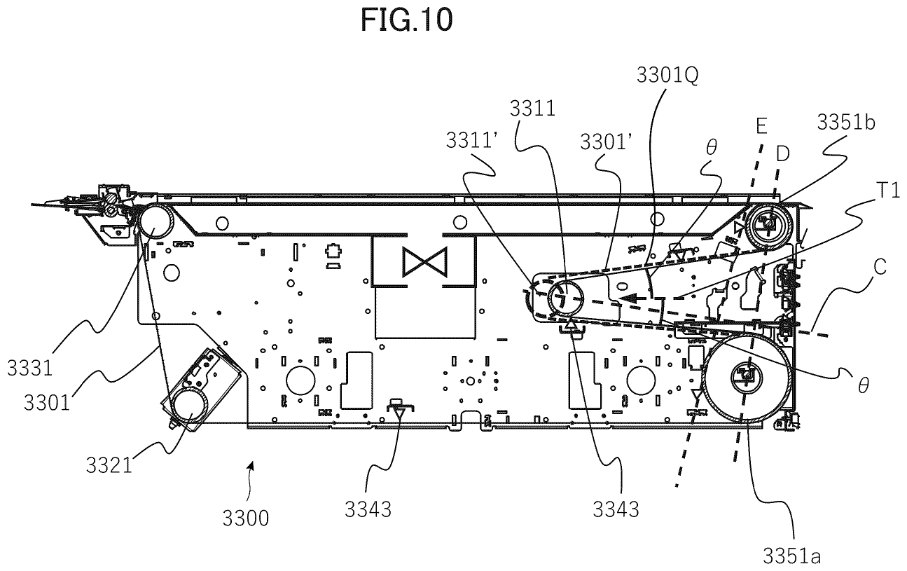

FIG. 10 illustrates a belt stretched state in a state where the belt is expanded. The drying belt 3301 is heated to “approximately 80° C.” by being heated by the warm air from the warm air blowing unit 3400 (refer to FIG. 2) and by the heating of the heating roller 3351a and the heating roller 3351b. In the present embodiment, the drying belt 3301 made of resin is used. Therefore, a coefficient of linear expansion is approximately “2 to 10×10⁻⁵·K⁻¹”, and when the circumference length of the belt is “2600 mm”, the drying belt 3301 may expand for “approximately 15 mm” by the influence of heat. In response to such expansion of the belt, the tension roller 3311 presses the drying belt 3301 further inward compared to before the belt was expanded, and enters to a position as illustrated by the broken line in FIG. 10 (refer to 3311′ and 3301′ in the drawing).

As illustrated in FIG. 10, the tension roller 3311 urges the drying belt 3301 from the outer side toward the inner side between the heating roller 3351a and the heating roller 3351b. The tension roller 3311 causes the drying belt 3301 to protrude inward of an common external tangent E on an inner side of the drying belt 3301 among the common external tangents of the heating roller 3351a and the heating roller 3351b. The tension roller 3311 presses the drying belt 3301 such that a belt winding angle of the drying belt 3301 at the heating rollers 3351a and 3351b becomes “135° or greater”. Preferably, the belt winding angle of the heating rollers 3351a and 3351b is preferably close to “180°”. For example, the tension roller 3311 should be moved to a position where the angle θ formed of the drying belt 3301 by the stretching of the belt by the tension roller 3311 and the heating rollers 3351a and 3351b with respect to the urging direction T1 of the tension roller 3311 becomes an acute angle (45° or smaller).

Thereby, the heating efficiency of the drying belt 3301 by the heating rollers 3351a and 3351b may be improved, and the influence of variation of the belt winding angle on rollers other than the heating rollers 3351a and 3351b when the drying belt 3301 has been expanded by rising of temperature may be suppressed. For example, in a case where the drying belt 3301 has been expanded for “20 mm”, even if the position of intrusion of the tension roller 3311 is moved by “10 mm”, the winding angle of the drying belt 3301 on rollers other than the heating rollers 3351a and 3351b will not be varied greatly.

As described, by providing the tension roller 3311 between the heating roller 3351a and the heating roller 3351b, the range in which the stretched state is varied by the expansion of the drying belt 3301 is limited to the area between the heating roller 3351a and the heating roller 3351b. Further, since the tension roller 3311 moves to a direction in which the belt winding angle on the heating roller 3351a and the heating roller 3351b is increased, the heating efficiency of the drying belt 3301 by the heating rollers 3351a and 3351b will not be deteriorated compared to a state before movement of the roller.

In order to realize a great belt winding angle at each of the heating roller 3351a and the heating roller 3351b, it is preferable to move the tension roller 3311 to a direction C intersecting a straight line D that connects a center of rotation of the heating roller 3351a and a center of rotation of the heating roller 3351b. Further, by moving the tension roller 3311 toward a roller having a greater output of heat or a roller having a greater diameter among the heating rollers 3351a and 3351b, the heating efficiency of the drying belt 3301 may be enhanced.

As described above, according to the present embodiment, the tension roller 3311 that applies tension to the drying belt 3301 is arranged such that the stretched portion 3301Q of the drying belt 3301 stretched by the heating rollers 3351a and 3351b is pressed from the outer side toward the inner side. Further, the steering roller 3321 that performs position control of the drying belt 3301 is arranged between the driving roller 3331 and the heating roller 3351a with respect to the direction of rotation of the drying belt 3301. Thereby, in a state where the drying belt 3301 is expanded and the belt is extended by the influence of heat, even when the tension roller 3311 is moved, the range in which the stretched state of the drying belt 3301 is varied may be limited to the area between the heating roller 3351a and the heating roller 3351b. In the area between the heating roller 3351a and the heating roller 3351b, the belt is moved in a direction where the belt winding angle at the heating rollers 3351a and 3351b increases, such that the heating efficiency of the drying belt 3301 by the heating rollers 3351a and 3351b is not deteriorated compared to before the movement of the tension roller 3311. Even when the tension roller 3311 has been moved, since the belt winding angle of the steering roller 3321 is not changed, the meandering control of the belt by the steering roller 3321 may be performed stably, similar to the state before movement of the belt. As descried, according to the present embodiment, even when the tension roller 3311 has been moved, efficient heating of the drying belt 3301 by the heating rollers 3351a and 3351b and the suppression of meandering of the drying belt 3301 by the steering roller 3321 may be realized.

### Other Embodiments

In the embodiment described above, the drying belt 3301 made of resin has been used, but the present technique is not limited thereto, and the drying belt 3301 made of metal may be used. However, since the coefficient of linear expansion is greater in the drying belt 3301 made of resin or rubber compared to that made of metal, the effect described above may be obtained easily.

According to the embodiment described above, a configuration was adopted in which the steering roller 3321 is displaced by the pivoting steering arm 3323a to realize a meandering control property of the belt, but the present technique is not limited thereto. For example, the technique may adopt an automatic alignment mechanism of regulating the amount of meandering of the drying belt 3301 by providing a regulation rib at an end portion of the drying belt 3301, or may adopt a meandering control mechanism of causing a tension difference at the end portion of the belt.

According to the embodiment described above, an example has been illustrated of a case where both the heating rollers 3351a and 3351b are heating rollers that heat the drying belt 3301, but it may be possible to have at least either one of the heating rollers 3351a and 3351b formed of a heating roller. In that case, however, in order to efficiently heat the sheet S, the heating roller 3351b that stretches the drying belt 3301 at a position closest to the sheet conveyance surface 3301P is preferably formed of the heating roller.

According to the embodiment described above, the heater 3353 is disposed within the heating rollers 3351a and 3351b, but the present technique is not limited thereto. For example, the heater may be arranged on an outer circumference of the rollers to heat the heating rollers 3351a and 3351b.

According to the embodiment described above, the inkjet recording apparatus 100 was described as an example of the image forming apparatus, but the present technique is not limited thereto. The present technique may be applied to an image forming apparatus of an electrophotographic system using toner to achieve a similar effect as the present embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-172852, filed Oct. 4, 2023, which is hereby incorporated by reference herein in its entirety.

What is claimed is:

1. A sheet conveyance apparatus configured to convey a sheet, comprising:
a belt having an endless shape configured to rotate and convey a sheet;
a first roller configured to stretch the belt on a downstream side of a sheet conveyance surface of the belt conveying the sheet in a direction of rotation of the belt;
a second roller configured to stretch the belt on an upstream side of the sheet conveyance surface in the direction of rotation;
a third roller configured to stretch the belt at a position upstream of the second roller in the direction of rotation;
a steering roller disposed between the first roller and the third roller in the direction of rotation and configured to tilt and move the belt in a width direction intersecting the direction of rotation; and
a tension roller configured to apply a tension to the belt,
wherein at least one of the second roller and the third roller is a heating roller configured to heat the belt, and
wherein the tension roller is configured to press a stretched portion of the belt that is stretched by the second roller and the third roller from an outer side toward an inner side to apply the tension to the belt.

2. The sheet conveyance apparatus according to claim 1, wherein both the second roller and the third roller are the heating roller configured to heat the belt.

3. The sheet conveyance apparatus according to claim 1, wherein the second roller is the heating roller configured to heat the belt.

4. The sheet conveyance apparatus according to claim 1, wherein the tension roller is configured to cause the belt to protrude inward of an common external tangent on an inner side of the belt among the common external tangents of the second roller and the third roller.

5. The sheet conveyance apparatus according to claim 4, wherein the tension roller is configured to press the belt such that a winding angle of the belt on the heating roller is 135° or greater.

6. The sheet conveyance apparatus according to claim 1, wherein the tension roller is configured to move to a direction intersecting a straight line connecting a center of rotation of the second roller and a center of rotation of the third roller.

7. An image forming apparatus comprising:
the sheet conveyance apparatus according to claim 1; and
an image forming unit configured to form an image on a sheet.
